(19) United States
(12) Patent Application Publication
(10) Pub. No.: US 2010/0201096 A1
(43) Pub. Date: Aug. 12, 2010

(54) Skate car

(76) Inventor: Jeeng-Neng Fan, Yang mei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,071

(22) Filed: Feb. 12, 2009

(51) Int. Cl. B62M 1/00; B62K 5/04

(52) U.S. Cl. 280/230

(57) ABSTRACT

A skate car includes a left and right swayable front pipe coupled to front ends of the left and right support rods and an automatic position-restoring swayable driving wheel pivotally coupled to rear ends of left and right support rods separately. A user can either swing a vertical pipe of the front pipe to the left and right sides to swing the front driving wheel installed at the lower end of the vertical pipe, or apply a force to the left and right support rods to swing the swayable and automatic position-restoring left and right rear driving wheels to the left and right sides, or do both of the above, to drive the car body to roll forward along the S-shaped path and slide forward smoothly, so as to achieve a multiple of operating modes and gain more fun for the fitness exercise.

### BACKGROUND OF THE INVENTION

1. Field of the Invention

The present invention relates to an improved skate car capable of achieving a smooth sliding effect by a multiple of operations such as swinging a vertical pope to left and right sides, alternately applying a force to left and right support rods or swinging the vertical pope to left and right sides and alternately applying a force to the left and right support rods, and a vertical pipe with a front pipe working with left and right transversal screw bolts and left and right vertical pivots can be spread open or folded together directly with left and right support rods to spread open and fold the skate car easily and conveniently.

2. Description of the Related Art

In a triangular design of a skate car whose handlebar can be swayed to left and right sides to drive a car body as shown in FIGS. 1 and 2, the skate car comprises a front pipe 10, a freely rotating vertical pipe 11 pivotally coupled to the front pipe 10, a handlebar 12 disposed at the top of the vertical pipe 11, a front driving wheel 13 installed at the bottom of the vertical pipe 11 through a front fork 111, a pivotal ear 101 disposed at the bottom of the front pipe 10 for pivotally coupling a locking end 202 of an extended section 201 of left and right support rods 20 by a screw bolt 102 and a cushion element 103, a first through shaft 104 disposed on the pivotal ear 101 and at a backward position corresponding to the front pipe 10 for pivotally coupling a rotating member 14, a transversal second through shaft 141 disposed separately on both ends of the rotating member 14 for passing an elastic shock absorbing member 15 and securing the elastic shock absorbing member 15 into its position by a screw bolt 142 and the cushion element 143, and the left and right elastic shock absorbing members 15 are transversally accommodated in the front shaft sleeve 203 of the left and right support rods 20, such that the front pipe 10 can swing to left and right by using the ground touching point of the front driving wheel 13 as a pivot point and the first through shaft 104 as a rotating point, and the elastic shock absorbing member 15 is provided for absorbing the shocks and restoring the positions of the locking end 202, the extended section 201 and the shaft sleeve 203 of left and right support rod 20 exerted with the left and right swinging pressure. In addition, a load carrying wheel 21 is installed separately at the rear ends of the left and right support rods 20, and a carrier 22 is installed at the position of the load carrying wheel 21. After a user stands on the carrier 22 and holds the handlebar 12 with both hands, the user still can swing the handlebar 12 to the left and right sides to deviate the front driving wheel 13 to the left and right sides by swinging to roll forward in a S-shaped path, such that the whole skate car can achieve the effect of sliding forward for the fitness exercise purpose.

With reference to FIGS. 3 and 4, a folding structure disposed proximate to the front end of the left and right support rods 20 comprises: a pivotal ear 204 coupled to an end of shaft sleeve 203; a clamp 205 coupled to an end of a carrier 22 for pivotally coupling the pivotal ear 204 by a pivot 206; a sheath hole 2051 disposed at an end of the clamp 205 for accommodating a spring 207 and a pin 208, wherein the front end of the pin 208 is latched into a latch hole 2041 of the pivotal ear 204 by the resilience of the spring 207; a poke button 209 installed on a circumferential surface of the pin 208 and provided for separating the pin 208 from the latch hole 2041 by applying a force to move the poke button 209 backward, such that after the poke button 209 separates the pin 208 from the latch hole 2041, the support rod 20 installed at the carrier 22 and load carrying wheel 21 for using the pivot 206 as a rotating point for the folding operation, so as to reduce the overall volume of the skate car. When the pin 208 is latched into the latch hole 2041 by the resilience of the spring 207, the support rod 20 can be used for the operation of spreading open the skate car.

Undeniably, the aforementioned skate car can provide users the expected fitness exercise effect and achieve the effect of folding and reducing the volume of the skate car, but the conventional skate car still has the following drawbacks:

1. Since a user can slide the whole car body forward by swinging the handlebar to left and right sides to swing the front driving wheel 13, but the force produced by both legs of the user cannot be applied alternately to the load carrying wheels 21 at the rear ends of the two support rods 20 to drive and move the car body, therefore it requires significantly more efforts to drive the skate car, and the movement is monotonous and even unsmooth and stiff.

2. Since the force produced by both legs of the user cannot be applied alternately to the two load carrying wheels 21, therefore a wheel may be lifted above the ground and give rise to an accident easily, when the car body is sliding and making a turn.

3. Since the second through shaft 141 is passed transversally through the elastic shock absorbing member 15 and accommodated in the shaft sleeve 203, therefore poor shock absorption and position restoration are resulted due to lateral forces when the handlebar 12 swings to left and right, and the operation of the skate car will be unnatural and stiff.

4. Since it is necessary to install a folding structure separately at a position proximate to the front end of the left and right support rods 20 before the skate car can be folded the folding structure not just requires more components only, but also incurs a troublesome, complicated, laborious and cost-ineffective manufacturing process.

5. After the left and right support rods 20 are spread open for use, the folding structure uses the pin 208 to the user's body weight solely, and thus there will be a risk of having deformations, separations, falling off or breaking of components of the skate car if forces are applied continuously to operate and drive the skate car to slide on various road surface while carrying the weight of the user.

### SUMMARY OF THE INVENTION

In view of the shortcomings of the prior art, the inventor of the present invention based on years of experience in the related industry to conduct extensive researches and experiments, and finally developed a skate car in accordance with the present invention to overcome the shortcomings of the prior art.

Therefore, it is a primary objective of the invention to provide an improved skate car wherein a front pipe swayable to left and right is coupled to the front of left and right support rods, and an automatic position restoring swinging driving wheels is installed to the rear ends of the left and right support rods separately; wherein both ends of a through shaft coupled to the front pipe are pivotally coupled to positions proximate to the front end of the left and right support rods by a vertical pivot, and the front end is pivotally coupled to a pivotal ear of the front pipe by a transversal screw bolt separately, such that the transversal screw bolt can be loosened at the pivotal ear of the front pipe, and the left and right support rods can be folded together with the vertical pivot as a rotating point, and the front pipe with the vertical pipe, the handlebar and the front driving wheel can be folded to the left and right support rods by using the through shaft as the rotating point. On the other hand, the left and right transversal screw bolt are secured to the pivotal ear of the front pipe, and the skate car can be spread open for use in a simple and quick fashion. In addition, an elastic shock absorbing member is installed separately at positions of the vertical pivot corresponding to upper and lower ends of the left and right support rods, such that when the handlebar swings to left and right, the left and right support rods can apply an axial force vertically to the upper and lower ends of the elastic shock absorbing member to achieve better shock absorbing and position restoring effects. Further, a rear driving wheel is installed separately at the rear ends of the left and right support rods through a rear fork and a partially pressed slanting rotating pivot, so that when forces produced by both legs are applied alternately to the carrier at the rear end of the support rod, the rear driving wheel can be guided to restore its position automatically.

By swinging the handlebar to the left and right sides, the present invention can roll the front driving wheel along the S-shaped path to drive the car body forward, or apply a force alternately to swing the left and right support rods to the left and right sides to roll the left and right swayable and automatic position-restoring rear driving wheels forward along the S-shaped path to drive the car body, or do both, so as to drive the car body to move forward smoothly, achieve a multiple of operating modes and give more fun for the fitness exercise. Further, a through shaft of the front pipe is coupled to the left and right support rods through a vertical pivot and pivotally coupled to a pivotal ear of the front pipe through the transversal screw bolt, such that when the vertical pivot serves as a rotating point to lean both with each other or separate both from each other for the folding and unfolding operations respectively. The front pipe and the handlebar can use the through shaft as a rotating point for the folding and unfolding operations.

To make it easier for our examiner to understand the objects, characteristics and performances of the present invention, we use preferred embodiments accompanied with related drawings for the detailed description of the invention as follows.

### BRIEF DESCRIPTION OF THE DRAWINGS

FIG. 1 is perspective view of a conventional skate car;

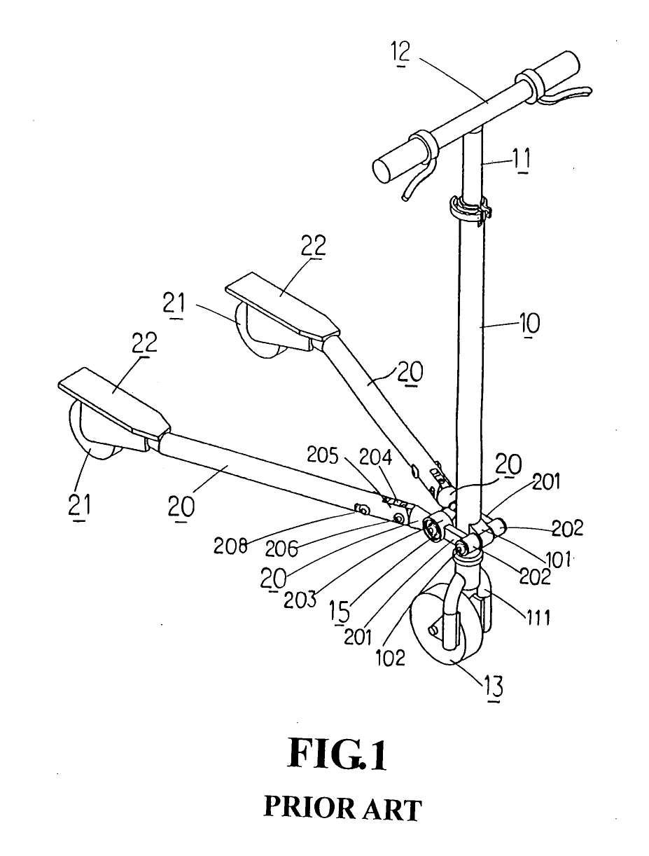

FIG. 2 is a schematic view of a structure of coupling a front pipe with left and right support rods;

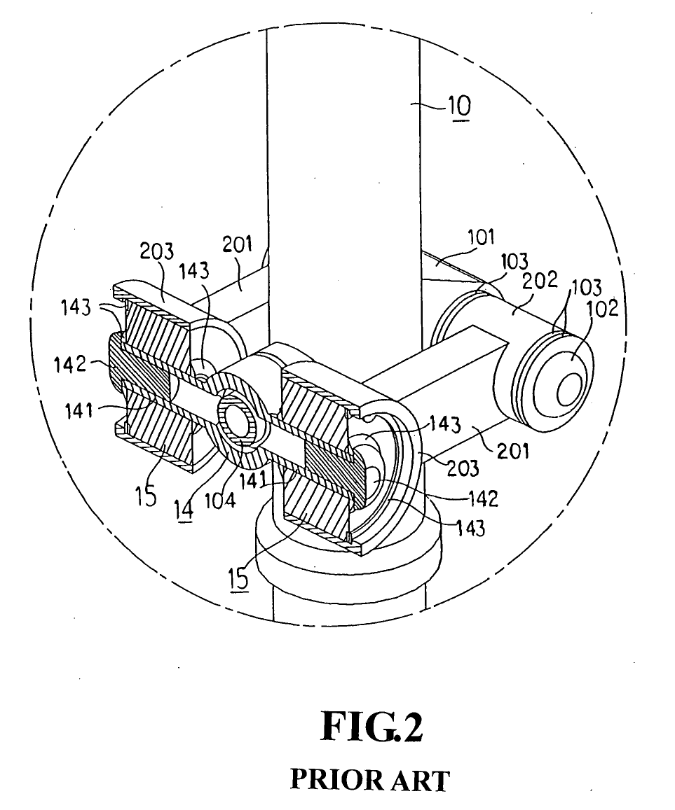

FIG. 3 is a schematic view of the left and right support rod folding structures of FIG. 1;

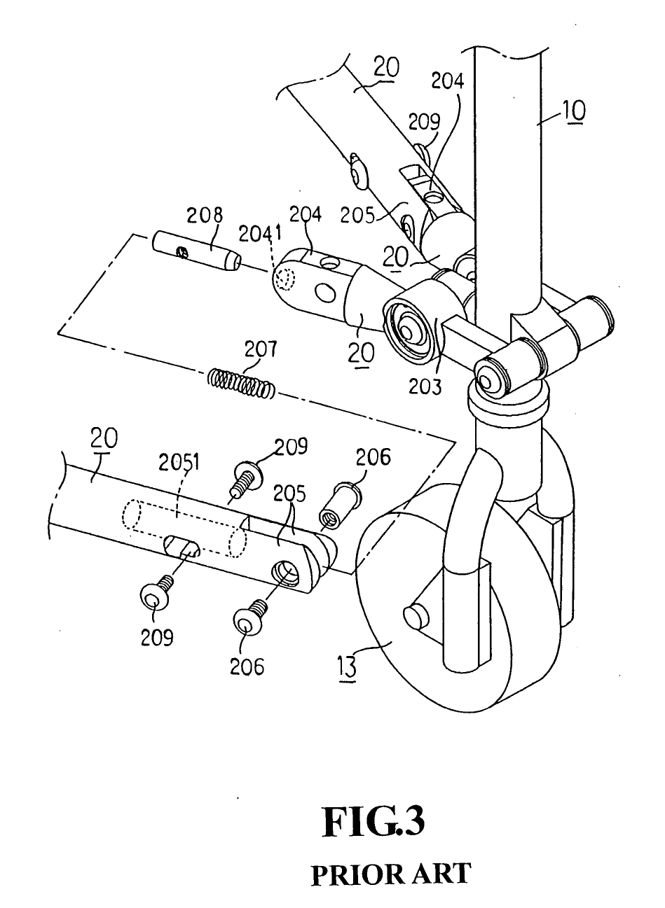

FIG. 4 is a schematic view of operating the folding structures of FIG. 3;

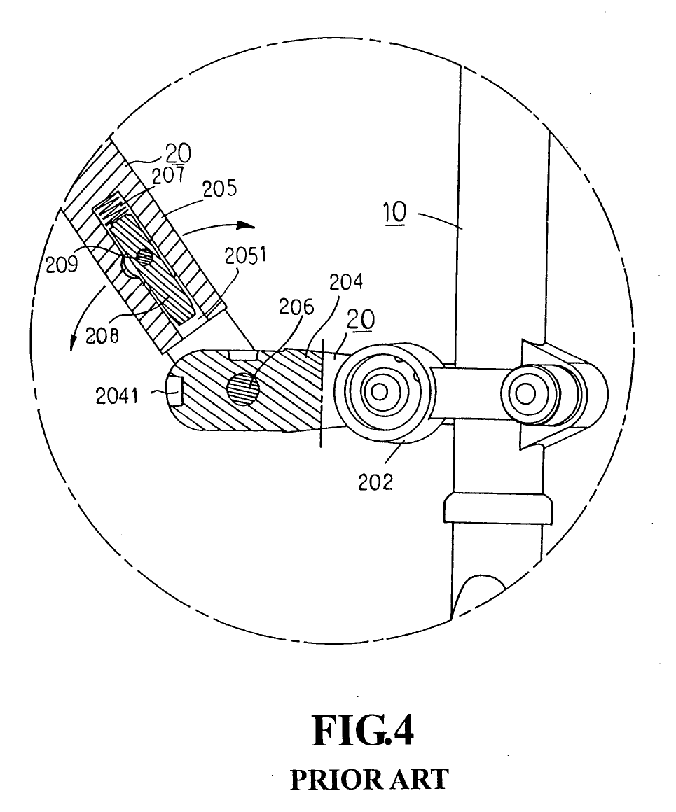

FIG. 5 is a perspective view of a preferred embodiment of the present invention;

FIG. 6 is a schematic view of a structure of coupling the front pipe with the left and right support rods as depicted in FIG. 5;

FIG. 7 is an exploded view of FIG. 6;

FIG. 8 is a bottom view of FIG. 6;

FIG. 9 is a side view of coupling left and right carriers to a front pipe through a vertical pivot, a transversal through shaft, and a swinging member in accordance with a preferred embodiment of the present invention;

FIG. 10 is a bottom view of folding left and right support rods in accordance with a preferred embodiment of the present invention;

FIG. 11 is a side view of swinging a front pipe to the left side in accordance with a preferred embodiment of the present invention;

FIG. 12 is a side view of swinging a front pipe to the right side in accordance with a preferred embodiment of the present invention;

FIG. 13 is a front view of folding a front pipe in accordance with a preferred embodiment of the present invention;

FIG. 14 is a front view of installing a rear driving wheel module at left and right support rods in accordance with a preferred embodiment of the present invention; and

FIG. 15 is a bottom view of operating a rear driving wheel module in accordance with a preferred embodiment of the present invention.

### DETAILED DESCRIPTION OF THE PREFERRED EMBODIMENTS

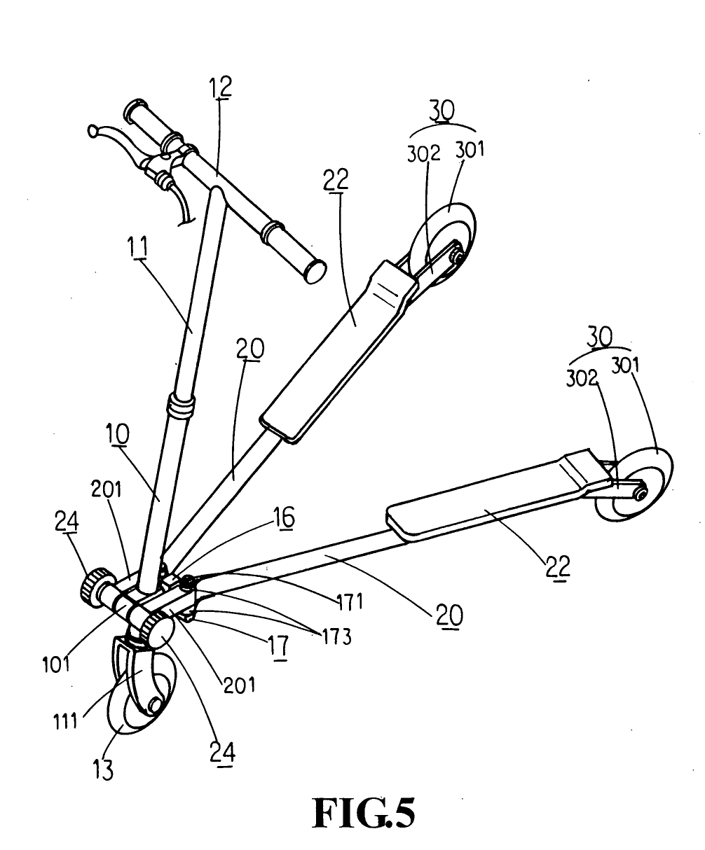

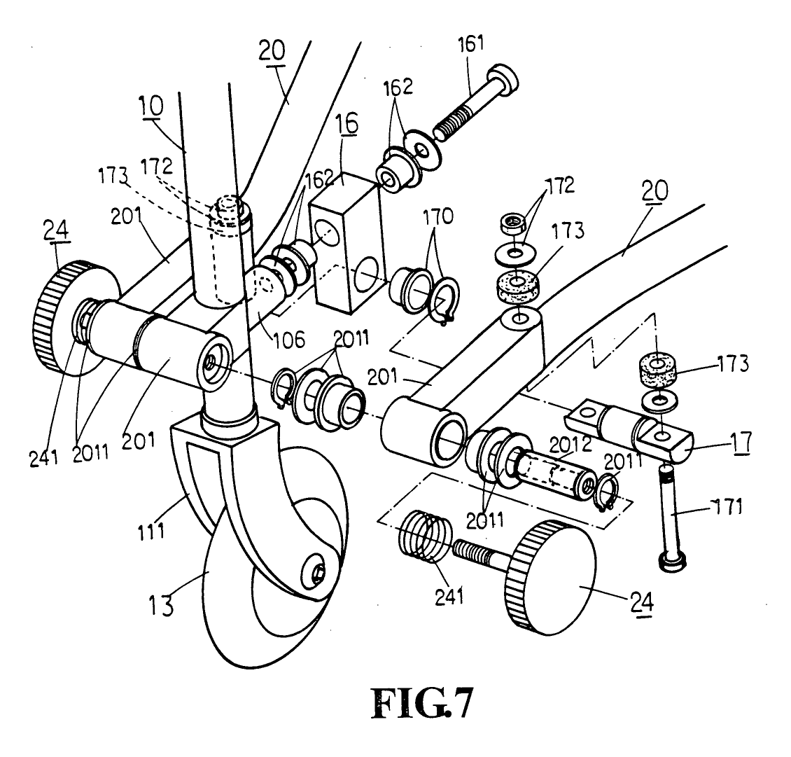

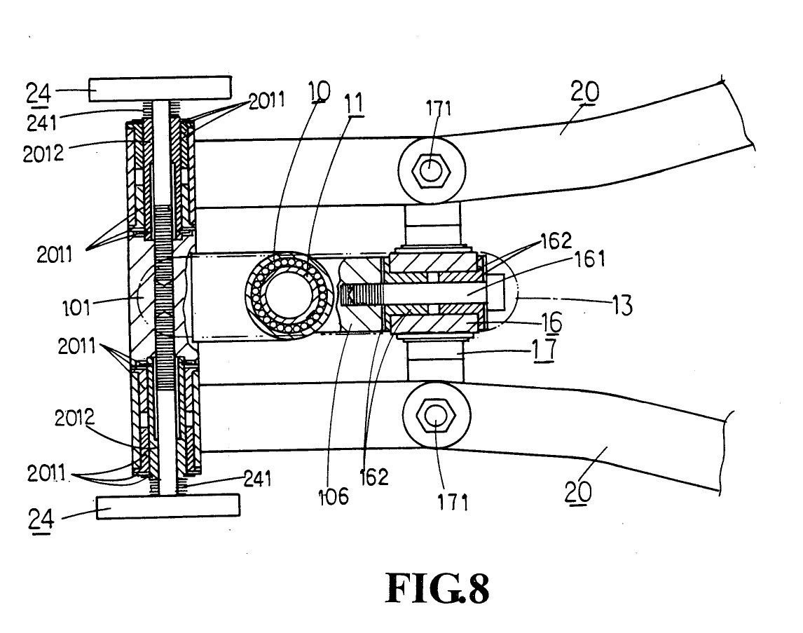

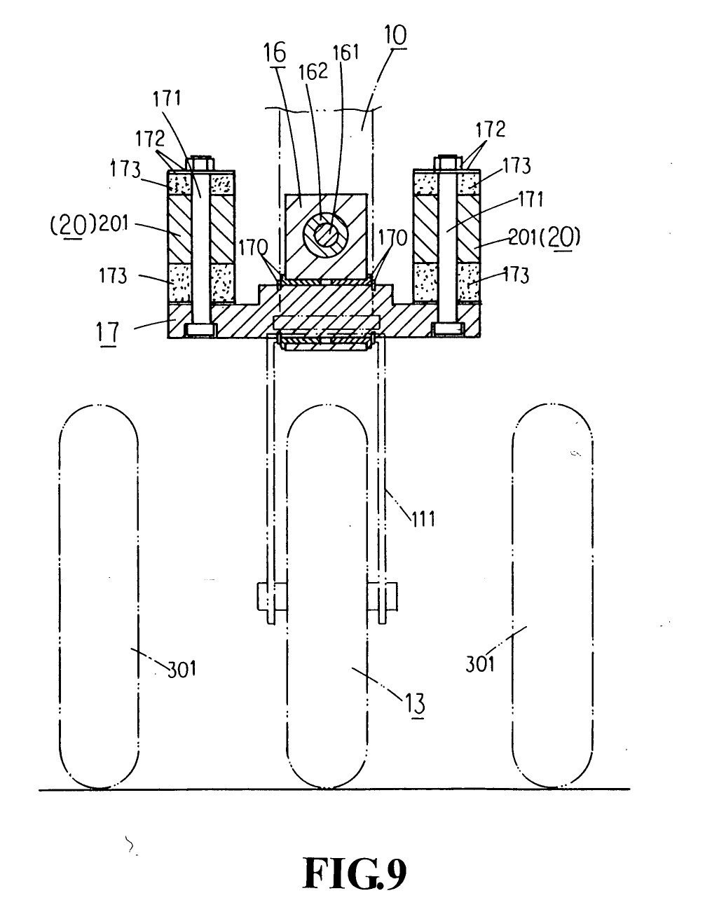

With reference to FIGS. 5 to 9 for an improved skate car of the present invention, the skate car comprises the skate car comprises a front pipe 10, a freely rotating vertical pipe 11 pivotally coupled to the front pipe 10, a handlebar 12 disposed at the top of the vertical pipe 11, a front driving wheel 13 installed at the bottom of the vertical pipe 11 through a front fork 111, a pivotal ear 101 disposed at the bottom of the front pipe 10, a pivotal base 106 disposed at a backward position corresponding to the pivotal ear 101, a swing block 6 is pivotally installed at the position of the pivotal base 106 by a pivot 161 and a cushion element 162 in corresponding front and back directions, and a through shaft 17 is transversally and pivotally coupled to a cushion element 170 at the position of the swing block 6, and both ends of the through shaft 17 are pivotally coupled to front ends of the left and right support rods 20 through a vertical pivot 171, a cushion element 172 and an elastic shock absorbing member 173 in a vertical direction, such that the left and right support rods 20 can be engaged or separated with each other by using the vertical pivot 171 as a rotating point, wherein the elastic shock absorbing member 173 is cushioned separated at upper and lower ends of the support rod 20, and an extended section 201 is disposed at the front end of the support rod 20 and a bushing 2012 is installed to the front end of the extended section 201 through a cushion element 2011 and provided for the installation of a transversal screw bolt 24 together with a resilient element 241, and the transversal screw bolt 24 can be secured to or loosened from the pivotal ear 101 of the front pipe 10.

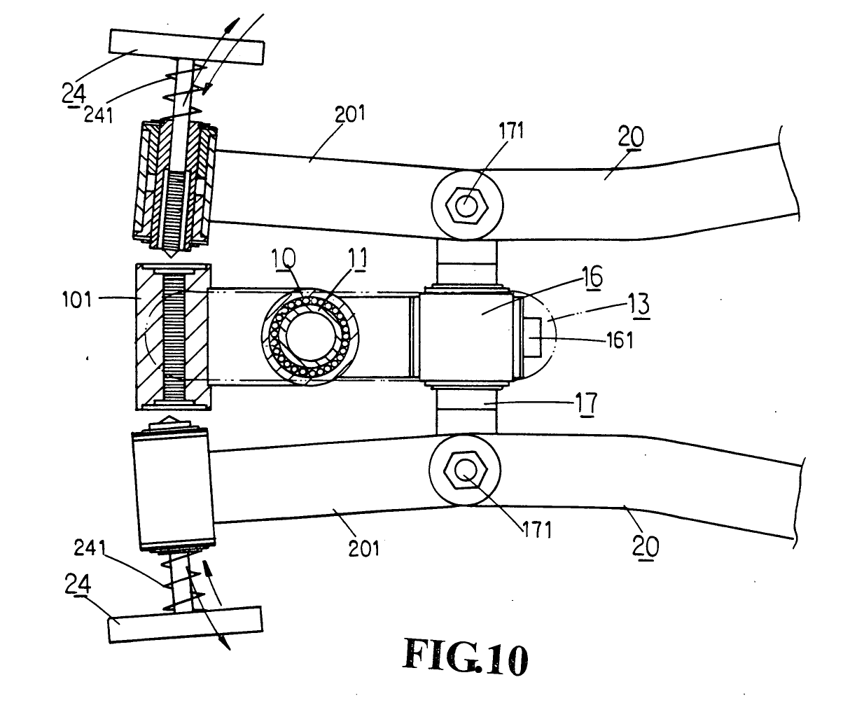

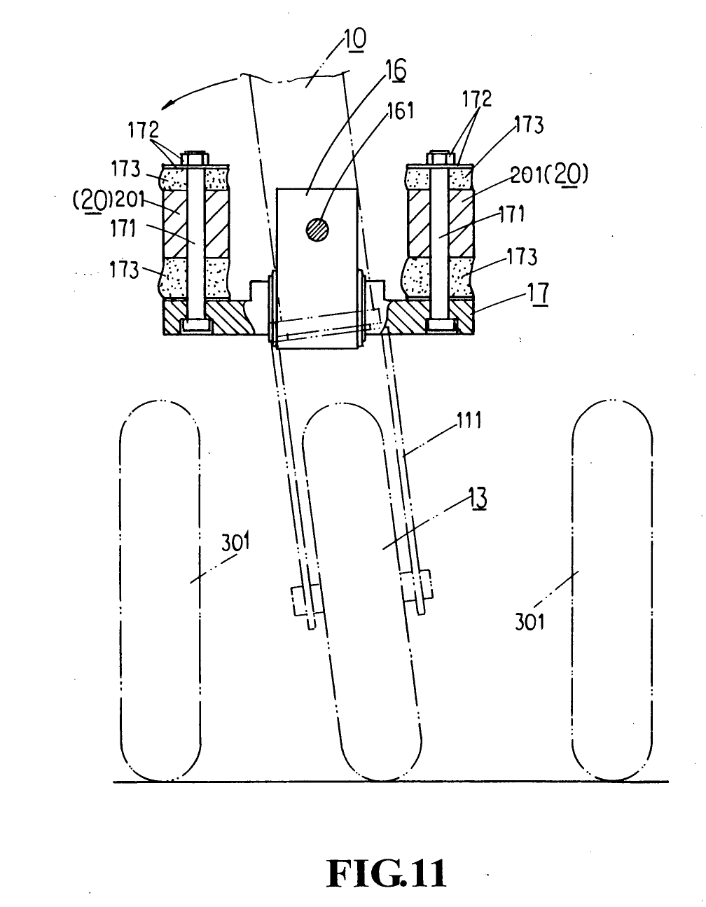

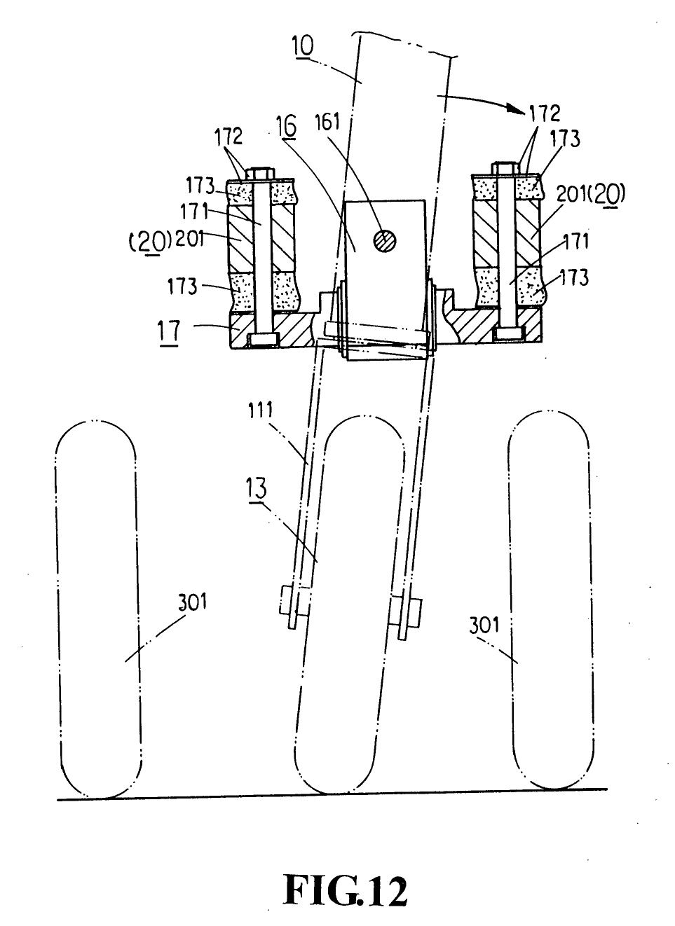

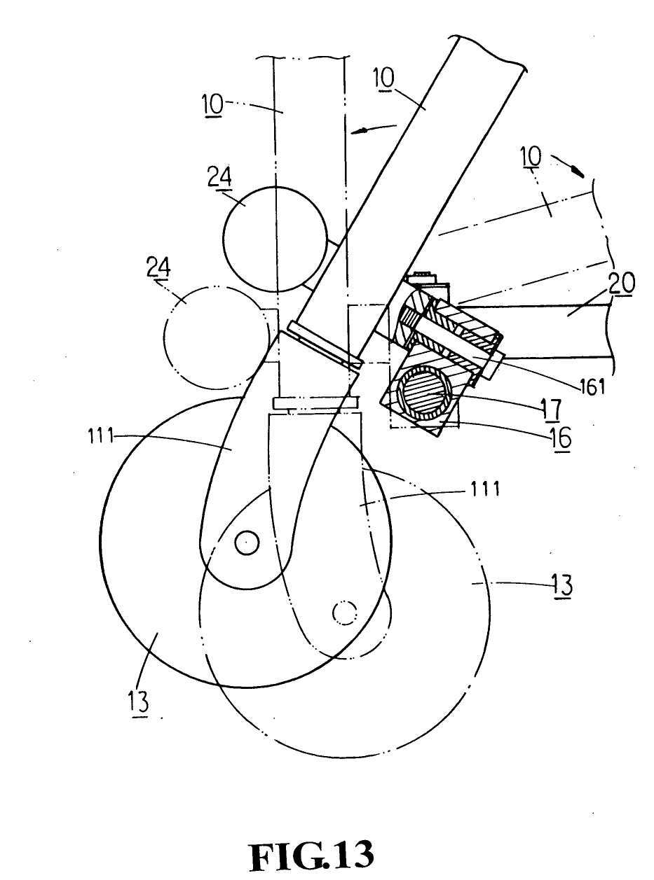

With reference to FIGS. 10 to 13, when the left and right support rods 20 are spread open by using the vertical pivot 171 as a rotating point, the transversal screw bolt 24 can be secured to engage the front end of the extended section 201 to the pivotal ear 101 of the front pipe 10 (as shown in FIGS. 5, 6 and 8). On the other hand, the transversal screw bolt 24 can be loosened to separate the pivotal ear 101 of the front pipe 10 (as shown in FIG. 10), such that the left and right support rods 20 can be engaged with each other by using the vertical pivot 171 as a rotating point. Further, the front ends of the extended sections 201 of the left and right support rods 20 are pivotally coupled to the pivotal ear 101 of the front pipe by the transversal screw bolt 24, and the pivotal base 106 of the front pipe 101 is pivotally coupled to the swing block 6 by the pivot 161, and the swing block 6 is coupled to the left and right support rods 20 by the through shaft 17 and the vertical pivot 171, such that if the transversal screw bolt 24 is secured to the pivotal ear 101 of the front pipe, the front pipe 10 together with the handlebar 12 will be able to swing to the left and right by using the pivot 161 pivotally coupled to the swing block 6 as a rotating point (as shown in FIGS. 11 and 12). On the other hand, if the transversal screw bolt 24 is loosened to separate the pivotal ear 101 of the front pipe 10, the left and right support rods 20 can be engaged with each other, and the front pipe 10 together with the handlebar 12 can be swayed and stacked by using the through shaft 17 passed to the swing block 6 as a rotating point in a direction towards the support rod 20 (as shown in FIG. 13).

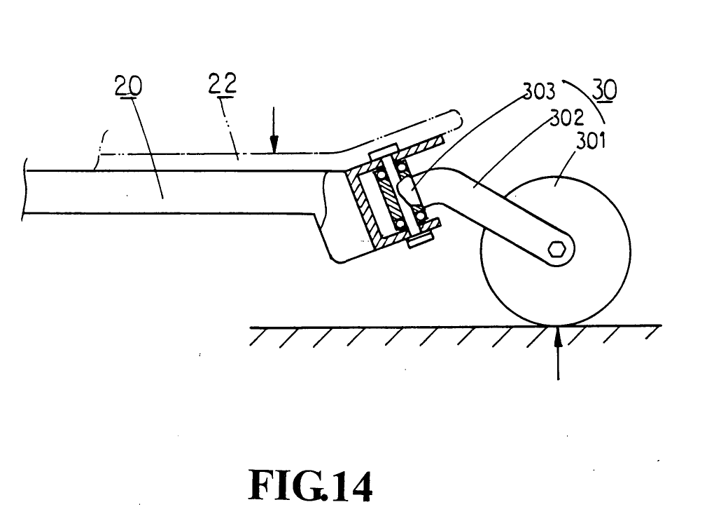

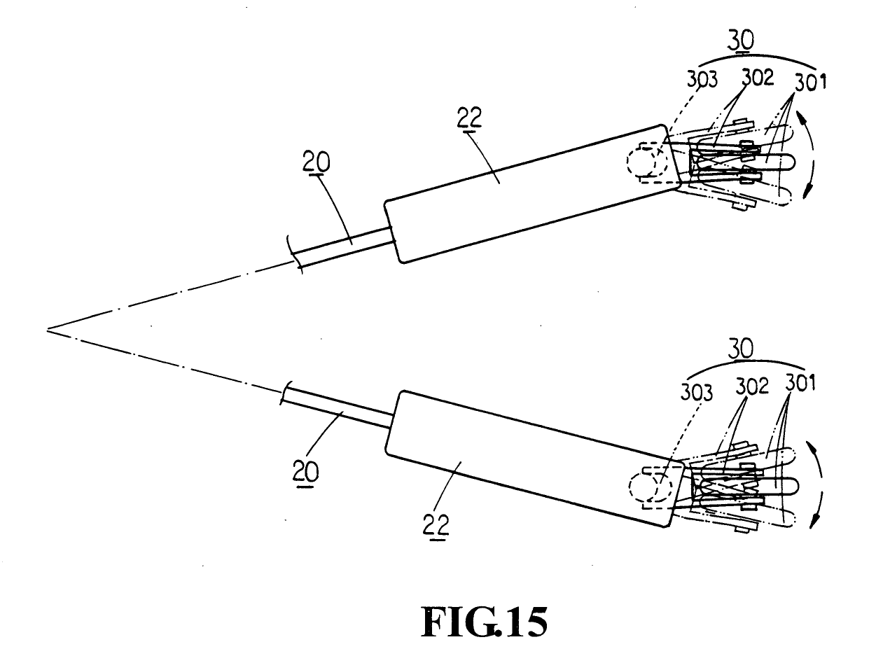

With reference to FIG. 14 together, a carrier 22 is installed on the left and right support rods 20 and provided for allowing a user's legs to stand on the carrier 22, and having a rear driving wheel module 30 partially pressed and pivotally coupled to the rear end of the carrier 22, wherein the rear driving wheel module 30 includes a rear driving wheel 301 partially pressed and pivotally coupled to the rear end of the support rod 20 by a rear fork 302 and a slanting rotating pivot 303, such that when the user's legs apply a force downward onto the carrier 22 together with the support rods 20, the rotating pivot 303 is partially pressed and pivotally and slantingly installed to automatically correct the movement of the rear driving wheel 301. In FIG. 15, the rear driving wheel module 30 is partially pressed and pivotally coupled to the rear end of the support rods 20, such that the user's legs apply a force alternately onto the left and right carriers 22, the left and right swayable rear driving wheels 301 will correct their movement and restoring their positions automatically. In other words, when forces are exerted onto the rear driving wheel 301, the position is restored automatically, and the movement will be corrected, so that after the user stands on the left and right carriers 22, the user can apply forces alternately to drive the rear driving wheel 301 to roll forward along a S-shaped path to slide the car body forward.

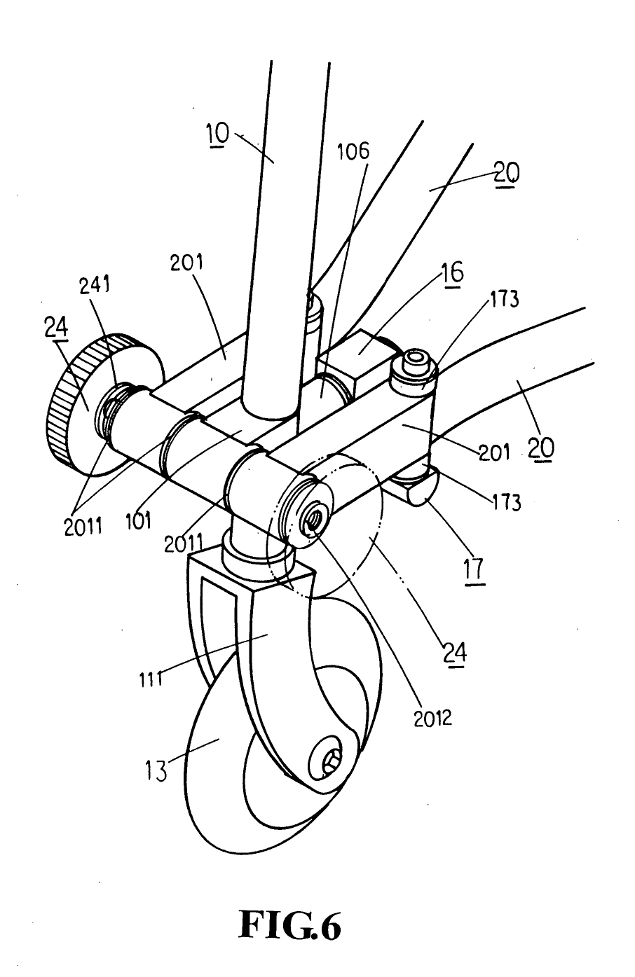

In FIGS. 6, 9, 11 and 12, if the left and right swayable handlebar 12 together with the front pipe 10 swing to the left and right to drive the front driving wheel 13 to roll forward along the S-shaped path and driving the car body to move forward, and the left and right support rods 20 coupled to the front pipe 10 will be pressed partially, and the elastic shock absorbing members 173 for absorbing shocks and restoring positions are used to install the vertical pivot 171 and the cushion element 172 to the upper and lower ends of the support rod 20 in the vertical direction, then the left and right support rods 20 will be swung to the left or to the right, and the elastic shock absorbing member 173 will provide better shock absorbing and position restoring effects along the vertical axial direction, such that the left and right swayable handlebar 12 can be operated more smoothly and naturally, and give a stable and safer effect for the user to stand on the left and right carrier 22 with the left and right rear driving wheel 301.

With the structure of the present invention, a user can twist or swing the handlebar 12 or twist the user's body to swing the front pipe 10 in order to drive the front driving wheel 13 to roll along the S-shaped path to drive the car body to slide forward or apply forces by both legs or twist the user's body to left and right rear driving wheel 301 drive the front driving wheel 13 to roll along the S-shaped path to drive the car body to slide forward, or do both of the above to achieve a multiple of operating modes and provide more fun to the skate car. By securing or loosening the extended section 201 at the front ends of the left and right support rods 20 to or from the pivotal ear 101 of the front pipe 10 through the transversal screw bolt 24, the front ends can use the vertical pivot 171 as a rotating point for the engaging or separating operation, and the front pipe 10 can use the through shaft 17 as a rotating point for the up and down swinging operations. Therefore, the front pipe 10, handlebar 12, and the left and right support rods 20 of the skate car can be used for folding and unfolding operations to achieve a convenient and simple folding effect.

What is claimed is:

1. An improved skate car, comprising a front pipe, a freely rotating vertical pipe disposed at the front pipe and having a handlebar and a front driving wheel installed at upper and lower ends of the vertical pipe respectively, a pivotal ear and a pivotal base disposed at corresponding positions of front and rear ends of the front pipe; left and right support rods, having a carrier thereon, a rear driving wheel module installed separately at rear ends of the left and right support rods, and having a front end coupled to the lower end of the front pipe and an extended section disposed towards the front, characterized in that a swinging member is pivotally coupled to the pivotal base of the front pipe, a transversal through shaft is pivotally coupled to the swinging member, and both ends of the through shaft have elastic shock absorbing members are pivotally coupled to front ends of the left and right support rods through vertical pivots, and the extended sections at the front ends of the left and right support rods are pivotally installed through a transversal screw bolt and secured to or loosened from the position of the pivotal ear of the front pipe, and a rear driving wheel module is pivotally installed separately to the rear ends of the left and right support rods in a freely swinging and partially pressed way.

2. The improved skate car of claim 1, wherein the elastic shock absorbing member is disposed and cushion at tipper and lower ends or lower and upper ends of the left and right support rods respectively.

3. The improved skate car of claim 1, wherein the rear driving wheel module includes a rear driving wheel pivotally installed at the rear ends of left and right support rods in a partially form through a rear fork and a slanting rotating pivot.
